(19) United States
(12) Patent Application Publication
(10) Pub. No.: US 2007/0145012 A1
(43) Pub. Date: Jun. 28, 2007

(54) Slurry and method for chemical-mechanical polishing

(76) Inventors: Joon-Sang Park, Seoul (KR); Jong-Won Lee, Seongnam-si (KR); Chang-Ki Hong, Seongnam-si (KR); Bo-Un Yoon, Seoul (KR); Jae-Dong Lee, Suwon-si (KR)

Correspondence Address: HARNESS, DICKEY & PIERCE, P.L.C., P.O. BOX 8910, RESTON, VA, 20195, US

(21) Appl. No.: 11/542,256

(22) Filed: Oct. 4, 2006

(30) Foreign Application Priority Data
Oct. 4, 2005 (KR) 10-2005-0093022

(51) Int. Cl. C09K 13/00; C03C 15/00; B44C 1/22

(52) U.S. Cl. 216/89; 252/79.1; 216/88

(57) ABSTRACT

Disclosed is a slurry and method for chemical-mechanical polishing operation. The slurry may contain abrasive particles, an oxidizer, a pH controller, a chelating agent and water. The viscosity of the slurry may be in the range of about 1.0 cP—about 1.05 cP, so that the step difference may be reduced between regions with patterns and without patterns even after completing the chemical-mechanical polishing operation. A permissible rate of depth of focus (DOF) may not need to be controlled in the subsequent photolithography operation, which may enable the subsequent photolithography operation to be conducted by an optical system with relatively low DOF.

### PRIORITY STATEMENT

This U.S. non-provisional patent application claims priority under 35 U.S.C. § 119 to Korean Patent Application No. 2005-93022, filed on Oct. 4, 2005, in the Korean Intellectual Property Office (KIPO), the entire contents of which are hereby incorporated by reference.

### BACKGROUND

1. Field

Example embodiments relate to a slurry and a method for chemical-mechanical polishing (CMP) in fabricating semiconductor devices.

2. Description of the Prior Art

CMP technology may be used for manufacturing semiconductor devices, for example, in forming metal contacts, interconnection lines and/or flattening insulation films. A CMP operation may be carried out with uniform polishing and plainness over a chip region. In general, a CMP operation may produce erosion that results from partial over-polishing caused by the distribution of target material to be polished and/or the density of patterns. The erosion may be deeper at boundaries where the pattern density varies.

Morphology of a target material to be polished may affect the subsequent photolithography process. If there is generated erosion and/or EOE due to an undesired polishing condition, it may cause a reduction in the margin of DOF (depth of focus) in a subsequent photolithography process. As a result, pattern deformation and/or cutoff of the interconnection may occur in the subsequent processes, thereby affecting reliability of a semiconductor device.

### SUMMARY

Example embodiments are directed to a slurry with uniformity and plainness to a target material after chemically and mechanically polishing the target material. Example embodiments are also directed to a method for CMP offering uniformity and plainness to a target material to be polished.

Example embodiments provide a chemical-mechanical polishing slurry including abrasive particles, an oxidizer, a pH controller, a chelating agent, and water. The viscosity of the chemical-mechanical polishing slurry may be about 1.0 cP—about 1.05 cP. The viscosity may be controlled by a water-soluble polymer. If a CMP operation is conducted with slurry that is lower than about 1.00 cP in viscosity, a polishing rate may be lower. When the viscosity of slurry is higher than about 1.05 cP, an undesired polishing condition may occur with an EOE rate over about 200 Å and a pattern density of about 20%.

Example embodiments provide a CMP method that polishes a conductive material by means of slurry including abrasive particles, an oxidizer, a pH controller, a chelating agent, and water. The viscosity of the slurry may be about 1.0 cP-1.05 cP. The viscosity may be controlled by a water-soluble polymer.

A further understanding of the nature and advantages of example embodiments herein may be realized by reference to the remaining portions of the specification and the attached drawings.

### BRIEF DESCRIPTION OF THE DRAWINGS

Example embodiments will be more clearly understood from the following detailed description taken in conjunction with the accompanying drawings. FIGS. 1-3 represent non-limiting, example embodiments as described herein.

FIGS. 1A and 1B illustrate typical patterns for monitoring a CMP progress;

FIGS. 2A and 2B are graphic diagrams showing states of polishing along the density of the CMP monitoring pattern; and

FIG. 3 is a graphic diagram showing the amount of erosion by the viscosity of CMP slurry.

### DETAILED DESCRIPTION OF EXAMPLE EMBODIMENTS

Example embodiments will be described below in more detail with reference to the accompanying drawings. Example embodiments may, however, be embodied in different forms and should not be constructed as limited to the embodiments set forth herein. Rather, these embodiments are provided so that this disclosure will be thorough and complete, and will fully convey the scope of example embodiments to those skilled in the art. In the following descriptions, the same reference numerals will be used throughout the drawings and the descriptions to refer to the same or like parts.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90° or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

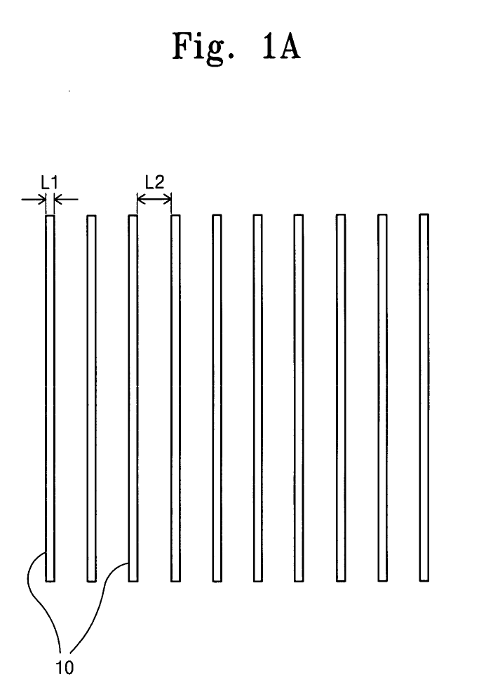

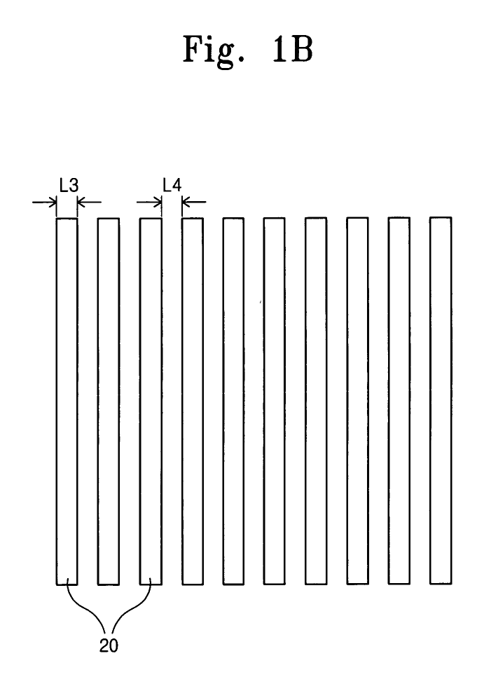

FIGS. 1A and 1B illustrate patterns for monitoring CMP progress. FIG. 1A illustrates a monitoring pattern where pattern density of the target material is about 20%, while FIG. 1B illustrates a monitoring pattern where density of the target material is about 50%.

Referring to FIGS. 1A and 1B, the CMP monitoring patterns may be configured with linear patterns 10 and 20. As illustrated in FIG. 1A, in the monitoring pattern with the density of about 20%, an interval L2 between linear patterns 10 may be four times of a line width L1 of the linear pattern 10. As illustrated in FIG. 1B, in the monitoring pattern with the density of about 50%, an interval L4 between the linear patterns 20 may be designed to be the same as a line width L3 of the linear pattern. The line widths L1 and L3 of the monitoring linear patterns 10 and 20 each with about 20% and about 50% may be formed in the same configuration, enabling their polishing conditions to be compared with each other according to pattern density.

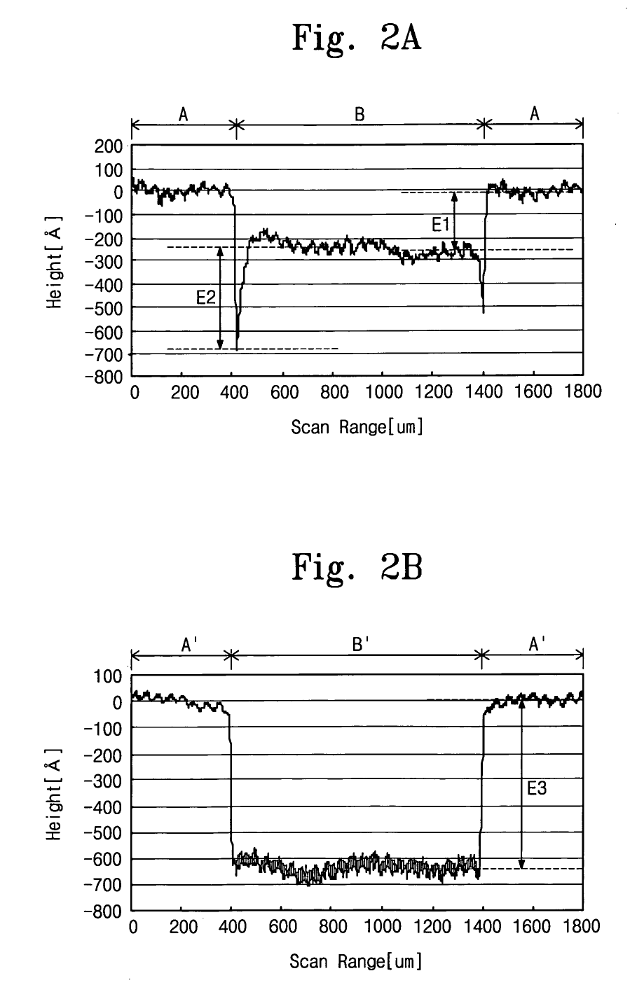

After conducting a CMP pattern with the CMP monitoring patterns as illustrated in FIGS. 1A and 1B, the resultant polishing conditions may be monitored and depicted on graphs shown in FIGS. 2A and 2B. If the patterns are for monitoring the metal interconnections, the linear patterns 10 and 20 may be formed of tungsten (W). After forming grooves in an insulation film for the linear patterns, a metal film may be entirely deposited thereon and a CMP operation may be monitored. A polishing condition may be variable in accordance with the density of the linear patterns 10 and 20.

In FIGS. 1A and 1B, the line width of the monitoring pattern may be about 0.25 μm and the CMP operation may be monitored after depositing tungsten on a silicon oxide film including the grooves. A time of CMP operation may be established at an end point detection (EPD) time+about 30% and amounts of the silicon oxide film etched may be about 250 Å and about 350 Å.

Referring to FIG. 2A, when conducting the CMP operation on the metal layer after depositing the tungsten metal layer in the insulation film including the grooves, erosion may occur in the monitoring pattern with a density of about 20%. The patterned region B may be leveled lower than a depth E1 in a region A including a peripheral insulation film, because of the difference in polishing speed between the metal layer and the insulation film. In addition, there may be edge over erosion (EOE) at the boundaries of the peripheral insulation region A and the patterned region B. The edge over erosion (EOE) may be further eroded by E2 more than E1.

Referring to FIG. 2B, the monitoring pattern with the density of about 50% may have erosion E3 that is deeper than E1 of the about 20% density monitoring pattern, but there may be no EOE at an interface between a repetitive pattern region B′ and a non-patterned region A′. Such erosion and EOE may cause differences of depths in interconnection layers and may degrade operational uniformity of a device, resulting in controlling a margin of DOF during the subsequent photolithography process. In accordance with the gap of plainness in the regional pattern density on a wafer or chip, there may be a way of depositing and flattening an additional insulation layer. Example embodiments propose an advanced CMP slurry for the metal interconnection layer so as to overcome the problems of erosion and EOE.

Table 1 as follows shows kinds of CMP slurry and results measured from erosion and EOE by viscosity in the about 20% density monitoring pattern. A line width of the linear pattern may be about 0.17 μm, and the pattern density may be about 20%. The EPD may be established at about +30% resulting from a CMP operation.

TABLE 1

| | Viscosity (cP) | Erosion (Å) | EOE (Å) | Total erosion |
|---|---|---|---|---|
| A | 1.04 | 77 | 39 | 116 |
| B | 1.18 | 96 | 289 | 385 |
| C | 1.25 | 289 | 385 | 674 |
| D | 1.65 | 481 | 558 | 1039 |
| E | 2.05 | 285 | 866 | 1251 |
| F | 2.12 | 635 | 693 | 1328 |

Referring to Table 1, while monitoring a polishing condition after completing the CMP operation, the erosion and EOE may increase as the viscosity increases without depending on the composition of the slurry. When the rate of erosion and EOE is lower than 1.0 cP, the slurry may not be applied into the CMP operation because of a relatively slow polishing speed.

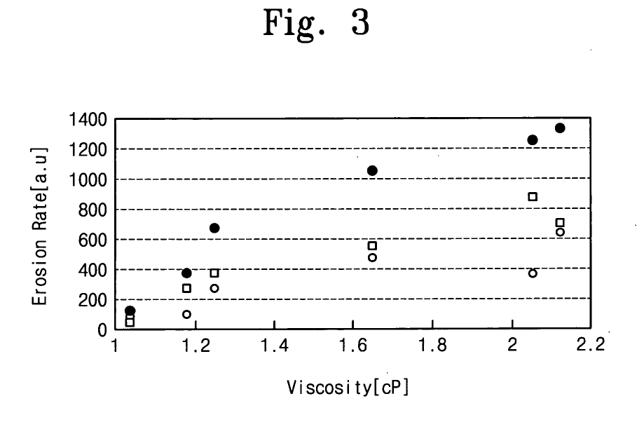

FIG. 3 is a graphic diagram depicting the feature of Table 1 in order to show the trend of erosion and EOE. In the graph, vacant quadrangles may correspond with erosion while filled quadrangles may correspond with the maximum amount of erosion in accordance with the amount of total erosion at an EOE region relative to its peripheral region.

Referring to FIG. 3, the maximum amount of erosion may be about 16 Å when the viscosity is about 1.04 cP. The amount of erosion may increase as the viscosity increases. Thus, when the viscosity of the slurry is over about 2.0 cP, the erosion may be more than about 600 Å. The amount of erosion may decrease as the viscosity decreases. A permissible range of DOF may be about 200 Å in a photolithography operation.

In order to regulate a step difference when erosion is less than about 200 Å with the same polishing speed as relatively highly viscous slurry, the viscosity of the slurry according to example embodiments may be about 1.0 cP—about 1.05 cP. The CMP slurry according to example embodiments may contain abrasive particles, an oxidizer, a pH controller, a chelating agent, and water. The viscosity of the slurry may be adjusted by adding a water-soluble organic polymer thereto. The water-soluble organic polymer may be used as a viscosity controlling agent without degrading the functions of the oxidizer and pH controller contained in the CMP slurry. The abrasive particles may be made of metal oxide that is selected from the group consisting of silicon oxide (SiO₂), cesium oxide (CeO₂), aluminum oxide (Al₂O₃), and titanium oxide (TiO₂). The oxidizer may be selected from the group consisting of hydrogen peroxide (H₂O₂), oxygen (O₂), ozone (O₃), strong sulfuric acid, strong nitric acid, potassium permanganate (KMnO₂), and potassium dichromate (K₂Cr₂O₇). The chelating agent may be selected from the group consisting of ethylenediaminetetraacetic (EDTA) acid, EDTA-A, and PDTA-M. The pH of the slurry according to example embodiments may be about 2.0—about 5.0.

According to example embodiments, the viscosity of the slurry may be about 1.0 cP—about 1.05 cP, so that the step difference is reduced between regions with patterns and without patterns even after completing the chemical-mechanical polishing operation. A permissible rate of depth of focus (DOF) may not need to be controlled in a subsequent photolithography operation, which enables the subsequent photolithography operation to be conducted by an optical system with relatively low DOF.

While there has been illustrated and described what are presently considered to be example embodiments, it will be understood by those skilled in the art that various other modifications may be made, and equivalents may be substituted, without departing from the true scope of the claims. Additionally, many modifications may be made to adapt a particular situation to the teachings of example embodiments without departing from the central inventive concept described herein. Therefore, it is intended that example embodiments not be limited to the particular embodiments disclosed, but that the example embodiments include all embodiments falling within the scope of the appended claims.

What is claimed is:

1. A chemical-mechanical polishing slurry comprising abrasive particles, an oxidizer, a pH controller, a chelating agent, and water, wherein the viscosity of the chemical-mechanical polishing slurry is about 1.0 cP-1.05 cP.

2. The chemical-mechanical polishing slurry as set forth in claim 1, which further comprises:
a water-soluble polymer for adjusting the viscosity.

3. The chemical-mechanical polishing slurry as set forth in claim 1, wherein the abrasive particles are made of a metal oxide that is selected from the group consisting of silicon oxide (SiO₂), cesium oxide (CeO₂), aluminum oxide (Al₂O₃), and titanium oxide (TiO₂).

4. The chemical-mechanical polishing slurry as set forth in claim 1, wherein the oxidizer is selected from the group consisting of hydrogen peroxide (H₂O₂), oxygen (O₂), ozone (O₃), strong sulfuric acid, strong nitric acid, potassium permanganate (KMnO₂), and potassium dichromate (K₂Cr₂O₇).

5. The chemical-mechanical polishing slurry as set forth in claim 1, wherein the chelating agent is selected from the group consisting of ethylenediaminetetraacetic (EDTA) acid, EDTA-M, and PDTA-M.

6. The chemical-mechanical polishing slurry as set forth in claim 1, wherein the pH of the chemical-mechanical polishing slurry is about 2.0-5.0.

7. A method for chemical-mechanical polishing, the method including polishing a conductive material by means of slurry comprising abrasive particles, an oxidizer, a pH controller, a chelating agent, and water, wherein the viscosity of the slurry is about 1.0 cP—about 1.05 cP.

8. The method as set forth in claim 7, wherein the conductive material is a metal interconnection made of one selected from the group consisting of tungsten, aluminum, and copper.

9. The method as set forth in claim 7, wherein the slurry further comprises:
a water-soluble polymer for adjusting the viscosity.

10. The method as set forth in claim 7, wherein the abrasive particles are made of a metal oxide that is selected from the group consisting of silicon oxide (SiO₂), cesium oxide (CeO₂), aluminum oxide (Al₂O₃), and titanium oxide (TiO₂).

11. The method as set forth in claim 7, wherein the oxidizer is selected from the group consisting of hydrogen peroxide (H₂O₂), oxygen (O₂), ozone (O₃), strong sulfuric acid, strong nitric acid, potassium permanganate (KMnO₂), and potassium dichromate (K₂Cr₂O₇).

12. The method as set forth in claim 7, wherein the chelating agent is selected from the group consisting of ethylenediaminetetraacetic (EDTA) acid, EDTA-M, and PDTA-M.

13. The method as set forth in claim 7, wherein the pH of the slurry is about 2.0-5.0.
